(19) United States
(12) Patent Application Publication
(10) Pub. No.: US 2022/0024149 A1
(43) Pub. Date: Jan. 27, 2022

(54) WATERPROOF SEAMS AND METHODS OF MAKING THE SAME

(71) Applicant: Bemis Associates, Inc., Shirley, MA (US)

(72) Inventors: Richard A. Brown, Danville, NH (US); Jared M. Ide, Somerville, MA (US); Stephen A. Topper, Barre, MA (US)

(21) Appl. No.: 17/378,601

(22) Filed: Jul. 16, 2021

Related U.S. Application Data
(60) Provisional application No. 63/055,094, filed on Jul. 22, 2020.

(51) Int. Cl. B29C 65/00; B29C 65/02; B29C 65/48; A41D 31/10; A41D 27/24; D06H 5/00

(52) U.S. Cl. CPC B29C 66/7292; B29C 65/02; B29C 65/48; B29C 66/43; A41D 31/10; B29L 2031/4842; D06H 5/00; B29C 66/73187; B29K 2995/0069; D10B 2401/02; A41D 27/24

(57) ABSTRACT

Disclosed herein are improved overlapping waterproof seams and methods of producing the same.

### RELATED APPLICATIONS

This application claims the benefit of U.S. Provisional Application No. 63/055,094, filed Jul. 22, 2020, the teachings of which are incorporated herein by reference.

### BACKGROUND

Outerwear garments, such as coats and jackets, that are designed to be waterproof are commonly made from a two- or three-layer fabric where one of the layers is a waterproof membrane as shown in FIG. 1. The waterproof membrane typically lies on the inner surface of the main textile of the garment. To assemble the garment the seams are sewn to connect the different fabric panels. Along the inside of the garment the seams are traditionally covered with a water-proofing seam tape to make the garment fully waterproof. Typically, seam tape is either a two- or three-layer construction. A two-layer tape 60 includes a hot melt adhesive layer 80, and a waterproof membrane or barrier layer 30. A three-layer tape 70 additionally includes a fabric layer 90 (FIG. 2).

These tapes 60, 70 solve several problems: covering the seams reduces friction against the wearer, the tape 60, 70 can be printed to match the pattern of the inside coating or in case of three-layer tape 70, the fabric tape can be designed to match the liner fabric. A critical function of the seam tape 60, 70 is to bond to a waterproof membrane (in two-layer fabric) or a liner fabric (in three-layer fabric) and cover pin holes created by stitching, thereby making the seams waterproof. These tapes 60, 70 are usually applied using hot air sealing machines. The standard water proofing performance expected by the sealed seam is resistance to a Hydrostatic test at 3 psi for 2 minutes.

However, seam tapes 60, 70 experience various shortcomings. For example, for a seam tape 60, 70 to function properly its adhesive layer 80 must be able to melt quickly as it passes through the hot air sealing machine and flow enough to penetrate into the surface of the fabric. For hard to stick to fabrics, such as tightly woven nylon fabrics (e.g., ripstop), the temperature used to apply the tape 60, 70 may be raised to improve the melting of the adhesive layer 80; however, this often can cause defects in the fabric or melting of certain fabrics. Known seam tapes 60, 70 have a high flowing adhesive layer 80 that can penetrate the inner fabric layer and bond to the membrane of the fabric (for a three-layer construction, or direct to the membrane in a two-layer construction). Sometimes the adhesive when melted still has a high enough viscosity such that it cannot reach the waterproof membrane. This makes traditional TPU hot melt adhesive films unsuited for use in so-called tapeless seams.

In addition to sewing, there are bonded seams 95 in the market. Bonded seams 95 also need taping to make them fully waterproof. One method of creating a bonded seam is an overlap bonded seam 95, where a hot melt adhesive film is placed between two panels and heat sealed to create a bonded overlap seam (FIG. 3). The problem is that an overlapping seam has one part made of the inner (membrane) layer which is suitable for bonding and the other part made from the outer layer of the garment. This outer layer might be a heavy grade of polyester designed for physical strength and it is hard for the TPU hot melt adhesive to fully penetrate through it to reach the water proof membrane. This type of bonded seam 95 does not offer waterproofing under hydrostatic testing. However, an advantage of a fully bonded seam is that it yields a light weight garment which is cheaper and easier to manufacture.

### SUMMARY

Disclosed herein are methods of manufacturing waterproof seams. The methods include providing a first textile having at least a water penetrable layer and a waterproof layer; providing a second textile having at least a water penetrable layer and a waterproof layer; depositing an adhesive composition onto the water penetrable layer of the first textile; allowing the adhesive composition to completely penetrate through or wet out water penetrable layer of the first textile; placing the water penetrable layer of the first textile against the waterproof layer of the second textile in an overlapping configuration; and heat sealing the first textile to the second textile, thereby forming an overlapping waterproof seam.

In some embodiments, the adhesive composition comprises an aqueous polymer dispersion, a dispersed polymer powder, a dispersing agent, and a thickener. The aqueous polymer dispersion may be a polyurethane dispersion. In some embodiments, the adhesive composition further comprises a crosslinker, such as an isocyanate crosslinker. In some embodiments, the adhesive composition is free of solvents.

In some embodiments, the adhesive composition is deposited via a jetting process. The adhesive composition may be deposited in two continuous lines of adhesive composition, e.g., at about 5 mm distance between the two continuous lines. In some embodiments, the adhesive composition is further deposited as dots dispersed between the two continuous lines of adhesive composition. The dots of adhesive composition may be about 1 mm to about 1.5 mm in diameter, and in some aspects, are spaced about 1 mm to about 1.5 mm apart.

In some embodiments, the first textile and/or the second textile is a two-layer fabric. The two-layer fabric may include the waterproof layer and the water permeable layer, wherein the water penetrable layer is an outer shell fabric. In some embodiments, the adhesive composition is deposited onto the outer shell fabric of the first textile and penetrates through to the waterproof layer. In alternative embodiments, the adhesive composition is deposited onto the outer shell fabric of the first textile and wets out and bonds to the outer shell fabric. In some aspects, the outer shell fabric of the first textile is heat sealed to the waterproof layer of the second textile, e.g., by applying a pressure of 60 psi for a period of 10 to 30 seconds.

In some embodiments, the first textile and/or the second textile is a three-layer fabric. The three-layer fabric may include the waterproof layer and at least two water penetrable layers, wherein a first water penetrable layer is an inner liner fabric and a second water penetrable layer is an outer shell fabric. In some embodiments, the adhesive composition is deposited onto the outer shell fabric of the first textile and penetrates through to the waterproof layer. In some embodiments, the adhesive composition is deposited onto the outer shell fabric of the first textile and wets out and bonds to the outer shell fabric. In some embodiments, the adhesive composition is deposited onto the inner liner fabric of the first textile and penetrates through to the waterproof layer. In some aspects, the outer shell fabric of the first textile is heat sealed to the inner liner fabric of the second textile, e.g., by applying a pressure of 60 psi for a period of 10 to 30 seconds.

In some embodiments, the waterproof seam has a bond strength of about 3 lbs/inch. In other embodiments, the waterproof seam has a bond strength of about 8-9 lbs/inch. In some embodiments, the waterproof seam is fully waterproof under hydrostatic testing pursuant to AATCC 127.

Also disclosed herein are waterproof seams joining two textile sections. The waterproof seams include a first textile having at least a water penetrable layer and a waterproof layer; a second textile having at least a water penetrable layer and a waterproof layer; an adhesive composition applied to the water penetrable layer of the first textile, wherein the adhesive composition completely penetrated through or wet out the water penetrable layer of the first textile; the water penetrable layer of the first textile positioned against the waterproof layer of the second textile in an overlapping configuration; and an overlapping waterproof seam, formed by a heat seal, coupling the first textile and the second textile via the adhesive composition.

In some embodiments, the adhesive composition comprises an aqueous polymer dispersion, e.g., a polyurethane dispersion; a dispersed polymer powder; a dispersing agent; a thickener; and optionally a crosslinker, e.g., an isocyanate crosslinker. In some embodiments, the adhesive composition is free of solvents.

In some embodiments, the waterproof seam has a bond strength of about 3 lbs/inch. In alternative embodiments, the waterproof seam has a bond strength of about 8-9 lbs/inch. In some embodiments, the waterproof seam is fully waterproof under hydrostatic testing pursuant to AATCC 127.

### BRIEF DESCRIPTION OF THE FIGURES

Characteristics of the present invention will be more fully understood by reference to the following detailed description in conjunction with the attached drawings, in which:

FIG. 1 is a diagrammatic illustration showing the design of a two-layer fabric and a three-layer fabric garment comprising a waterproof membrane for use with the present invention;

FIG. 2 is a diagrammatic illustration showing the design of a two-layer seam tape and a three-layer seam tape comprising a barrier layer for use with the present invention;

FIG. 3 is a diagrammatic illustration showing an overlap bonded seam formed in accordance with a method and structure known in the prior art;

FIG. 4 is a diagrammatic illustration showing a waterproof overlap bonded seam of the present invention;

FIG. 5 is a photograph showing a cross-section of the overlapping seam in which a pigment has been added to the adhesive composition to highlight the flow of the adhesive to the membrane on each side of the seam;

FIG. 6 is a photograph showing fabric layers with the jetted adhesive composition prior to bonding;

FIG. 7 is photographs showing fabric layers with the jetted adhesive composition after bonding; and

FIG. 8 is a flowchart for forming a waterproof seam of the prevent invention.

### DETAILED DESCRIPTION

Disclosed herein are waterproof seams (e.g., waterproof overlapping seams) that are bonded using a liquid adhesive applied by a jetting process. The disclosed waterproof seams block the path of water and are fully waterproof under hydrostatic testing. The waterproof seams may be formed during the production of a garment. In some aspects, the liquid adhesive used to form the waterproof seam is able to adhere to substrates that are difficult to adhere to. In addition, the jetting of the liquid adhesive may result in lighter weight garments, for example as compared to garments prepared utilizing seam tape. Further, the waterproof seams exhibit improved breathability allowing moisture to diffuse out of the garment.

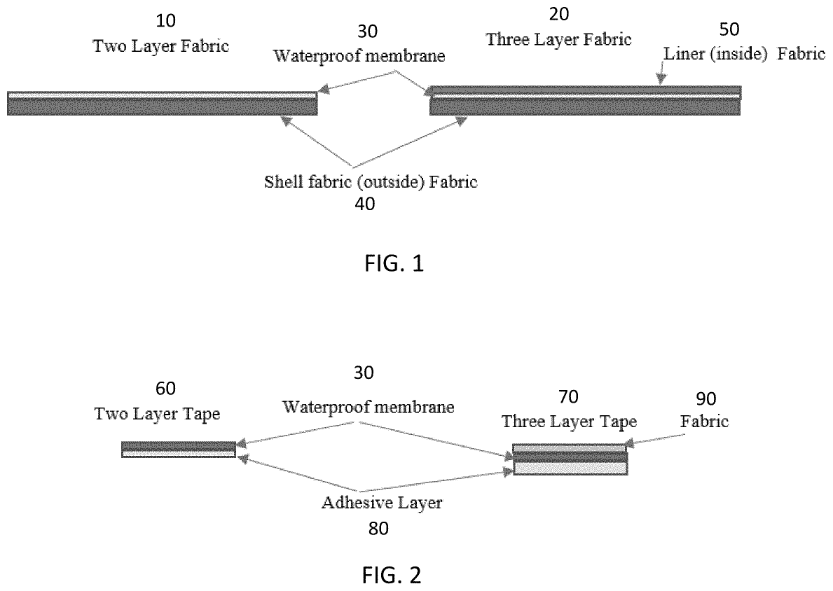

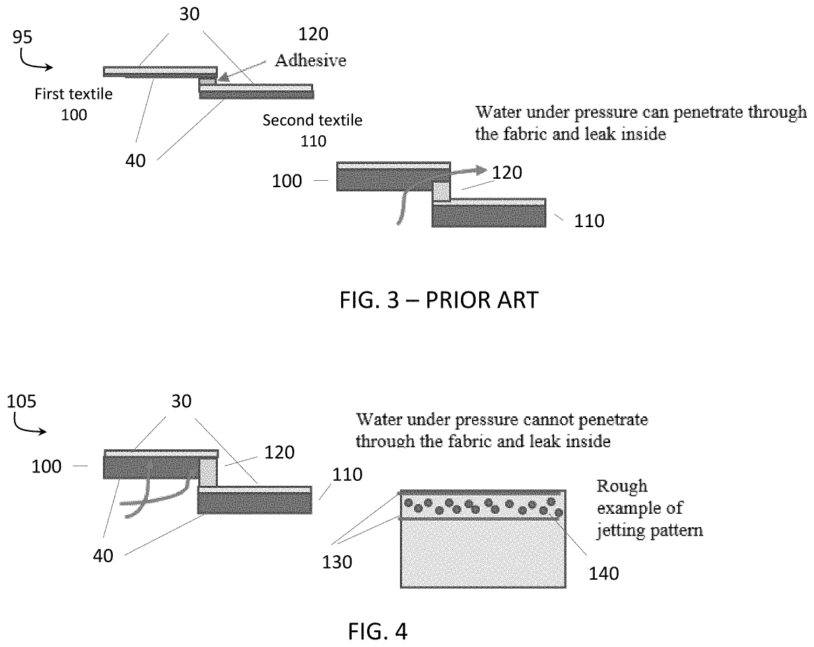

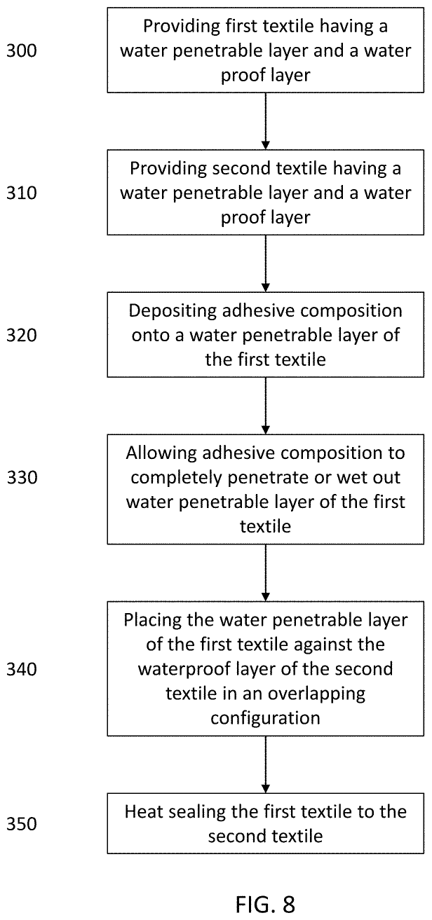

FIGS. 1-2 and 4-8, wherein like parts are designated by like reference numerals throughout, illustrate an example embodiment or embodiments of waterproof seams and methods for forming, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

Aspects of the invention are directed to methods of manufacturing a waterproof seam. The methods may comprise depositing an adhesive composition onto a first textile overlapping a second textile, allowing the adhesive to penetrate through the first textile, e.g., to reach the second textile, and heat sealing the first textile to the second textile. In other aspects, an adhesive is a reactive hot melt adhesive and therefore does not require the application of heat sealing to form a waterproof seam between a first textile and a second textile.

In some embodiments, the adhesive composition is a liquid adhesive. In some aspects, the adhesive composition is a water-based polyurethane. In some aspects, the adhesive composition is a reactive hot melt adhesive. In certain aspects, the adhesive composition comprises an aqueous polymer dispersion, a polymer powder, a dispersing agent, a thickener, and optionally a crosslinking agent. The adhesive composition may be free of solvents.

“Aqueous polymer dispersion,” “aqueous polymer emulsion,” and “aqueous polymer colloid” are used herein interchangeably. In some aspects, an aqueous polymer dispersion is a single polymer dispersion. In other aspects, an aqueous polymer dispersion is a blend of two or more aqueous polymer dispersions. In some aspects, the aqueous polymer dispersion acts as a dispersant. The aqueous polymer dispersion is a single aqueous polymer dispersion, or a blend of two or more aqueous polymer dispersions, which is capable of stabilizing a dispersion of a polymeric powder in water. In certain aspects, the aqueous polymer dispersion is selected from the group consisting of aqueous polyurethane-urea anionomers (also referred to herein as polyurethane dispersions or PUDs), aqueous acrylic emulsions, aqueous styrene acrylic emulsions, aqueous acrylic vinyl acetate emulsions, aqueous epoxy dispersions, aqueous polyamide dispersions, aqueous polyester dispersions (e.g., alkyds), and combinations thereof. As used herein, “acrylic” covers copolymers of any acrylic or methacrylic monomer, such as methyl methacrylate, n-butyl acrylate, ethyl hexyl acrylate, n-butyl methacrylate, acrylic acid, methacrylic acid, and the like.

In some embodiments, the aqueous polymer dispersion is an aqueous polyurethane dispersion or an aqueous acrylic emulsion. In some embodiments, the aqueous polymer dispersion is an aqueous polyurethane dispersion (e.g., an aliphatic polyester polyurethane). In some embodiments, the aqueous polymer dispersion is a blend of at least two polyurethane dispersions. Non-limiting examples of polyurethane dispersions include: NeoRez R-600, NeoRez R-9621, NeoRez R-9630, and NeoRez R-9430 from DSM; the Dispercoll range from Covestro, including Dispercoll U56, Dispercoll U54, and Dispercoll U2682; and Sancure 20025F from Lubrizol.

In some embodiments, the polymer powder is selected from the group consisting of co-polyesters, polyester urethanes, polyether urethanes, ethylene vinyl acetates, co-polyamides, polyamides, polyureas, polyolefins, polycarbonate urethanes, epoxy-polyester, and combinations thereof. In certain embodiments, the polymer powder is a polyamide. In certain embodiments, the polymer powder is a polyurethane powder. In certain embodiments, the polymer powder is a polycarbonate urethane. Non-limiting examples of polymer powders include: UNEX 4073 from Fixatti and Griltex 1A from EMS-Griltech.

In some aspects, a dispersing agent is a surfactant and/or a polymer dispersant. In some aspects, a dispersing agent is a non-ionic surfactant, an anionic surfactant, or a combination or hybrid of a non-ionic surfactant and an anionic surfactant. In some aspects, a dispersing agent is an acrylic polymer dispersant or a polyurethane dispersant. Non-limiting examples of dispersing agents include: Dowfax 3B2 from Dow; Dispex AA and Dispex CX from BASF; Metolat 355 and Metolat 388 from Munzig; Jeffsperse X3503 from Huntsman; Zetasperse 2500 from Evonik; Solsperse W100 from Lubrizol, and Altoma Carrier 10628 from Bolger & O'Hearn.

In some embodiments, a thickener is a water based acrylic. A thickener may be selected from the group consisting of a hydrophobically modified ethoxylated urethane (HEUR) thickener, a hydrophobically modified alkali swellable emulsion (HASE) thickener, a hydroxyethyl cellulose (HEC) thickener, a cellulosic thickener, an inorganic thickener (e.g., bentonite clays), and combinations thereof. Non-limiting examples of thickeners include: Altoma 1953 from Bolger & O'Hearn; Acrysol ASE-60, Acrysol DR-106, and Acrysol RM-845 from Dow; Rheovis PU 1251 from BASF; Borchi Gel ALA from Borchers GmbH; Coapur 6050 from Arkema; and Tego Rheo 8510 from Evonik.

In some embodiments, an adhesive composition further comprises a crosslinking agent (e.g., a reactive component to allow the system to crosslink). In some aspects, the crosslinking agent is a multi-functional isocyanate crosslinking agent or a blocked isocyanate crosslinking agent. In some aspects, the crosslinking agent is an aziridine crosslinking agent. Non-limiting examples of a crosslinking agent are Dispercoll BL XP 2514 and Imprafix 2794 from Covestro. A multi-functional isocyanate crosslinking agent, e.g., an encapsulated toluene diisocyanate (TDI) crosslinker, may be active at low temperatures (e.g., about 90° C.-110° C.) and may therefore be beneficial for use with a delicate fabric. A blocked isocyanate crosslinker requires a higher activation temperature (e.g., about 135° C.), and is therefore more stable for storage at high temperatures.

In some embodiments, an adhesive composition further comprises an additive. In some aspects, an additive is a defoaming agent, such as Foam Blast 301S from DyStar. In some aspects, an additive is a silicone additive, such as silicone containing additives from Byk. In some aspects, an additive is a multi-functional amine, such as Jeffamine T403 from Huntsman Performance Products. A multi-functional amine may be added to an adhesive composition comprising a crosslinker to provide additional stabilization.

Additional examples of adhesive compositions suitable for use in forming a waterproof seam are disclosed in U.S. application Ser. No. 16/910,733, the entirety of which is incorporated herein by reference.

In some embodiments, the adhesive composition is deposited, e.g., on a textile, via a liquid jetting system. In some embodiments, the liquid jetting system is a piezo-electric liquid jetting system (e.g., Nordson EFD Piezo Actuator Pico Pulse HD). In some embodiments, the adhesive composition is deposited on a first textile and/or a second textile. A textile may be a two-layer fabric or a three-layer fabric. In some embodiments, a textile comprises a waterproof membrane or layer. In some embodiments, a textile comprises a waterproof membrane or layer and at least one additional layer (e.g., at least one, at least two, at least three additional layers). The at least one additional layer may be a water permeable or water penetrable layer.

As shown in FIG. 1, a conventional textile may be a two-layer fabric 10 or a three-layer fabric 20. In some aspects, a two-layer fabric 10 comprises a waterproof membrane or water blocking layer 30, e.g., an inner waterproof membrane, and an outer layer 40, e.g., an outer shell fabric. In some aspects, a three-layer fabric 20 comprises a waterproof membrane or water blocking layer 30 between an outer layer 40, e.g., an outer shell fabric, and an inner layer 50, e.g., a liner fabric.

In some aspects, a fabric layer is an open weave fabric layer, such as a breathable or porous polyurethane. In some aspects, a fabric layer is a tightly woven fabric layer, such as a tightly woven nylon (e.g., rip stop nylon) or polyester. In some aspects, a fabric layer is treated with a coating. For example, a fabric layer, e.g., an outer shell fabric, may be treated with a durable water repellant (DWR). A DWR coating may be fluorinated, silicone, or olefinic in nature. In other aspects, a fabric layer may have a polyurethane coating. In some aspects, a fabric layer may be a polytetrafluoroethylene (PTFE) or may be coated with a PTFE film.

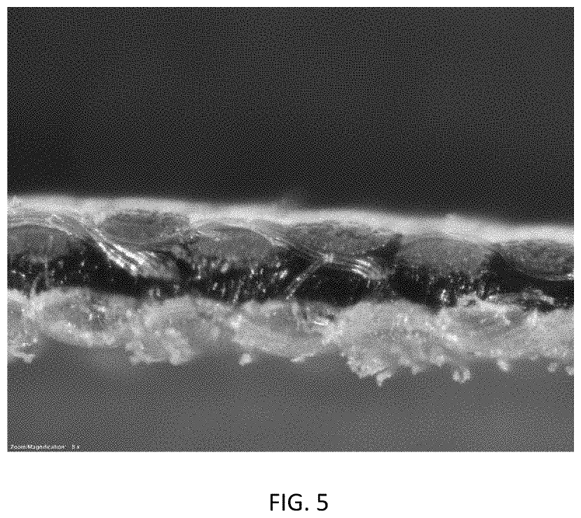

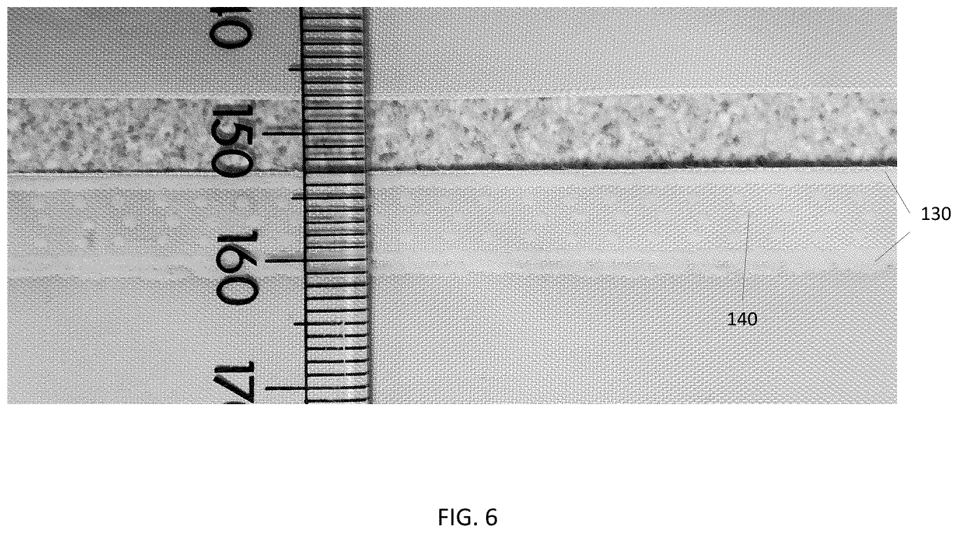

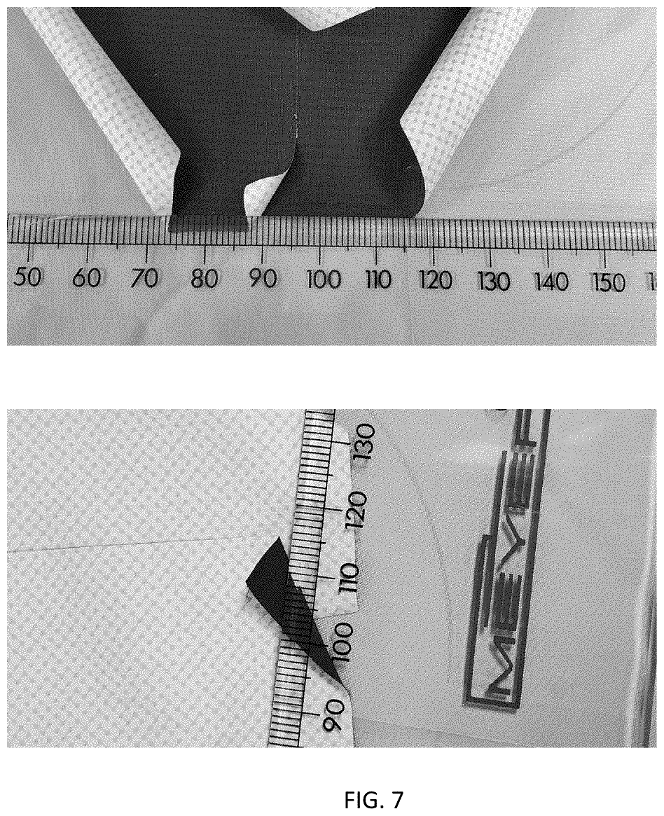

As shown in FIG. 4, in accordance with one embodiment, a waterproof seam 105 is depicted. An adhesive composition 120 is deposited on the first textile 100 on an outer layer 40, e.g., water penetrable layer, and is allowed to penetrate completely through to the waterproof or water blocking layer 30. In some aspects, the adhesive composition is deposited in continuous lines 130 with dots of adhesive composition 140 placed between the continuous lines (FIG. 6). The outer layer 40 of the first textile 100, having been fully penetrated by the adhesive composition 120, is placed such that it overlaps the second textile 110 and contacts the waterproof or water blocking layer 30 of the second textile 110. The first textile 100 is then heat sealed to the second textile 110, thereby forming an overlapped waterproof seam 105 that is able to withstand water pressure (FIG. 7). The penetration of the adhesive composition 140 into the layers of the textiles can be seen in FIG. 5, where blue dye was added to the adhesive composition to highlight the flow of the adhesive to the membrane on each side of the seam.

As outlined in FIG. 7, a method of forming a waterproof seam 105 may comprise the steps of: providing a first textile having at least a water penetrable layer and a waterproof layer 300; providing a second textile having at least a water penetrable layer and a waterproof layer 310; depositing an adhesive composition onto the water penetrable layer of the first textile 320; allowing the adhesive composition to completely penetrate through or wet out water penetrable layer of the first textile 330; placing the water penetrable layer of the first textile against the waterproof layer of the second textile in an overlapping configuration 340; and heat sealing the first textile to the second textile 350, thereby forming an overlapping waterproof seam 105.

In some aspects, the adhesive composition is deposited in a continuous line of an adhesive composition on a textile. In some aspects, the adhesive composition is deposited in at least two continuous lines of an adhesive composition on a textile. In some embodiments, the lines of adhesive composition are parallel to each other. The lines of adhesive composition may be about 2 mm to 8 mm, 3 mm to 7 mm, or 4 mm to 6 mm apart. In certain embodiments, the lines of adhesive composition are spaced about 5 mm apart. In some embodiments, the adhesive composition is further deposited as dots between the continuous lines of adhesive composition. In some aspects, the adhesive composition dots are about 0.5 mm to 2 mm, 0.75 mm to 1.75 mm, or 1 mm to 1.5 mm in diameter. In some aspects, the dots of adhesive composition are deposited about 0.1 mm to 3 mm, 0.25 mm to 2.75 mm, 0.5 mm to 2.5 mm, 0.75 mm to 2.25 mm, or 1 mm to 2 mm apart. In certain aspects, the dots of adhesive composition are deposited about 1 mm to 1.5 mm apart. The dots of adhesive composition deposited between the two continuous lines of adhesive composition may provide additional strength to the bond joining. For example, a bond formed with two continuous lines of adhesive composition and no dots of adhesive composition may be the most breathable, but weakest bond, as compared to a bond formed with two continuous lines of adhesive composition fully filled with dots of adhesive composition may be the least breathable, but strongest bond. In certain aspects, a bond formed with two continuous lines of adhesive composition and dots of adhesive composition that are dispersed about 1 mm to 1.5 mm apart may be both breathable and strong.

A liquid adhesive composition may be deposited on a fabric layer and then fully penetrate the fabric layer to reach the waterproof layer, thereby forming a water proof seal. In some embodiments, the liquid adhesive composition is deposited on an outer layer, penetrates through the outer layer, and reaches the waterproof layer. In some embodiments, the liquid adhesive composition is deposited on an inner layer, penetrates through the inner layer, and reaches the waterproof layer. In other aspects, a fabric layer exhibits a surface tension or lack of porosity making it difficult for the liquid adhesive composition to penetrate, e.g., the fabric layer is a tightly woven fabric or the fabric layer has a durable water repellant (DWR) coating. In such situations, a liquid adhesive composition comprising a surface active additive is applied to the fabric layer such that wetting out is achieved on the surface of the fabric layer.

In some embodiments, a first textile is heat sealed to a second textile. For example, a liquid adhesive composition is deposited on an inner layer of a first textile and is allowed to penetrate to a waterproof layer of the first textile, and the liquid adhesive composition is also deposited on an outer layer of a second textile and is allowed to penetrate to a waterproof layer or is allowed to wet out on the surface of the outer layer of the second textile, and the inner layer of the first textile is heat sealed to the outer layer of the second textile, thereby forming an overlapping waterproof seam. In some aspects, the time and pressure by which the heat sealing occurs may vary depending on the liquid adhesive composition being used. For example, the liquid adhesive composition has a specific temperature range (the glue line temperature) in which the adhesive is in a liquid state but is not so liquid such that it flows out of the desired bonding area. In addition, the temperature must be such that any crosslinking agent included in the adhesive composition becomes activated. In certain embodiments, the heat sealing may occur by applying pressure of about 60 psi to the textiles for a period of about 10 to 30 seconds.

A waterproof seam 105 formed by the methods described herein may be fully waterproof. For example, a waterproof seam 105 may be waterproof under hydrostatic testing according to one or more standards known to those of skill in the art. Hydrostatic testing comprises testing water pressure resistance according to one or more test standards, including, but not limited to AATCC 127 (AATCC TM127-2017(2018)e, Test Method for Water Resistance: Hydrostatic Pressure, developed in 1968 by AATCC Committee RA63 (Reaffirmed 2018; Editorially Revised 2019)); AATCC 35 (AATCC TM35-2018e, Test Method for Water Resistance: Rain, developed in 1947 by AATCC Committee RA63); BS EN ISO 811 (BS EN 20811 ISO 811, Textiles—Determination of resistance to water penetration—Hydrostatic pressure test, 2018 Edition, May 31, 2018); and NWSP 80.6 (NWSP 80.6 Evaluation of Water Resistance (Hydrostatic Pressure) Test). In some embodiments, a waterproof seam has a bond strength of about 3 lbs/inch, wherein the liquid adhesive composition does not include a crosslinker. In some embodiments, a waterproof seam has a bond strength of about 8 to 9 lbs/inch wherein the liquid adhesive composition comprises a crosslinker.

One skilled in the art readily appreciates that the present invention is well adapted to carry out the objects and obtain the ends and advantages mentioned, as well as those inherent therein. The details of the description and the examples herein are representative of certain embodiments, are exemplary, and are not intended as limitations on the scope of the invention. Modifications therein and other uses will occur to those skilled in the art. These modifications are encompassed within the spirit of the invention. It will be readily apparent to a person skilled in the art that varying substitutions and modifications may be made to the invention disclosed herein without departing from the scope and spirit of the invention.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. It is contemplated that all embodiments described herein are applicable to all different aspects of the invention where appropriate. It is also contemplated that any of the embodiments or aspects can be freely combined with one or more other such embodiments or aspects whenever appropriate. Where elements are presented as lists, e.g., in Markush group or similar format, it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. For example, any one or more active agents, additives, ingredients, optional agents, types of organism, disorders, subjects, or combinations thereof, can be excluded.

Where ranges are given herein, the invention includes embodiments in which the endpoints are included, embodiments in which both endpoints are excluded, and embodiments in which one endpoint is included and the other is excluded. It should be assumed that both endpoints are included unless indicated otherwise. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. It is also understood that where a series of numerical values is stated herein, the invention includes embodiments that relate analogously to any intervening value or range defined by any two values in the series, and that the lowest value may be taken as a minimum and the greatest value may be taken as a maximum. Numerical values, as used herein, include values expressed as percentages. For any embodiment of the invention in which a numerical value is prefaced by “about” or “approximately”, the invention includes an embodiment in which the exact value is recited. For any embodiment of the invention in which a numerical value is not prefaced by “about” or “approximately”, the invention includes an embodiment in which the value is prefaced by “about” or “approximately”.

“Approximately” or “about” generally includes numbers that fall within a range of 1% or in some embodiments within a range of 5% of a number or in some embodiments within a range of 10% of a number in either direction (greater than or less than the number) unless otherwise stated or otherwise evident from the context (except where such number would impermissibly exceed 100% of a possible value). It should be understood that, unless clearly indicated to the contrary, in any methods claimed herein that include more than one act, the order of the acts of the method is not necessarily limited to the order in which the acts of the method are recited, but the invention includes embodiments in which the order is so limited. It should also be understood that unless otherwise indicated or evident from the context, any product or composition described herein may be considered “isolated”.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

It is to be understood that the inventions disclosed herein are not limited in their application to the details set forth in the description or as exemplified. The invention encompasses other embodiments and is capable of being practiced or carried out in various ways. Also, it is to be understood that the phraseology and terminology employed herein is for the purpose of description and should not be regarded as limiting.

While certain compositions and methods of the present invention have been described with specificity in accordance with certain embodiments, the following examples serve only to illustrate the methods and compositions of the invention and are not intended to limit the same.

### EXEMPLIFICATION

### Adhesive Composition I

### Components:

1. PUD Dispercoll U56 supplied by Covestro (aqueous polymer dispersion); 43.5 g (50% solids, 21.7 g active)
2. Deionized water; 21.2 g
3. Altoma carrier 10628 dispersant supplied by Bolger & O'Hearn (dispersant); 10.9 g (100% active)
4. UNEX 4073RSL powder supplied by Fixatti (polymer powder); 23.9 g (100% active)
5. Altoma clear conc #1953 acrylic emulsion thickener supplied by Bolger & O'Hearn (thickener); 0.15 g
6. FoamBlast 301S supplied by Dystar (defoamer); 0.01 g (1% active)
7. Ammonia; 0.1 g (25% aqueous ammonia)

### Method of Mixing:

1. Weigh the water (21.2 g), the aqueous polymer dispersion (43.5 g), and the dispersant (10.9 g) into a cup and stir at 500 rpm.
2. Add polymer powder (23.9 g) into the vortex slowly, steadily increasing stir rate to 1000-1500 rpm.
3. Add 10 drops of thickener (0.1 g) and 1 drop of defoamer (0.01 g) to mixture.
4. Mix for 20 minutes.
5. Add a further 5-8 drops of thickener (0.05 g) to bring viscosity to 8000 cps, adjust pH to >7 (0.1 g) using aqueous ammonia and recheck after 24 hrs and adjust further if necessary

### Adhesive Composition II

### Components:

1. PUD Dispercoll U56 supplied by Covestro (aqueous polymer dispersion); 43.5 g (50% solids, 21.7 g active)
2. Deionized water; 21.2 g
3. Altoma carrier 10628 dispersant supplied by Bolger & O'Hearn (dispersant); 10.9 g (100% active)
4. UNEX 4073RSL powder supplied by Fixatti (polymer powder); 23.9 g (100% active)
5. Altoma clear conc #1953 acrylic emulsion thickener supplied by Bolger & O'Hearn (thickener); 0.1 g
6. FoamBlast 301S supplied by Dystar (defoamer); 0.01 g (1% active)
7. Dispercoll BL XP2514 supplied by Covestro (crosslinker); 3.3 g (40% active in water, 1.3 g active)
8. Ammonia; 0.1 g (25% aqueous ammonia)

### Composition Adjusted for 100% Total Volume

1. Dispercoll U56 40%
2. Water 22.9%
3. Dispercoll BL XP2514 3.2%
4. UNEX 4073RSL 23.1%
5. Altoma carrier 10628 10.5%
6. Altoma thickener 1953 0.1%
7. Dystar FoamBlast 301S 0.1%
8. Ammonia 0.1%

### Method of Mixing:

1. Weigh the water (21.2 g), the aqueous polymer dispersion (43.5 g), and the dispersant (10.9 g) into a cup and stir at 500 rpm.
2. Add polymer powder (23.9 g) into the vortex slowly, steadily increasing stir rate to 1000-1500 rpm.
3. Add 10 drops of thickener (0.1 g) and 1 drop of defoamer (0.01 g) to mixture.
4. Mix for 20 minutes.
5. Add crosslinker (3.3 g).
6. Add a further 5-8 drops of thickener (0.05 g) to bring viscosity to 8000 cps, adjust pH to >7 (0.1 g) using aqueous ammonia and recheck after 24 hrs and adjust further if necessary

### Adhesive Composition III

### Components:

1. PUD Dispercoll U56 supplied by Covestro (aqueous polymer dispersion); 43.5 g (50% solids, 21.7 g active)
2. Deionized water; 21.2 g
3. Altoma carrier 10628 dispersant supplied by Bolger & O'Hearn (dispersant); 10.9 g (100% active)
4. UNEX 4073RSL powder supplied by Fixatti (polymer powder); 23.9 g (100% active)
5. Altoma clear conc #1953 acrylic emulsion thickener supplied by Bolger & O'Hearn (thickener); 0.1 g
6. FoamBlast 301S supplied by Dystar (defoamer); 0.01 g (1% active)
7. Dispercoll BL XP2514 supplied by Covestro (crosslinker); 3.3 g (40% active in water, 1.3 g active)
8. Ammonia; 0.1 g (25% aqueous ammonia)
9. Jeffamine T-403 Polyoxypropylenetriamine supplied by Huntsman Performance Products (multi functional amine); 0.1-0.15% of total formulation

### Method of Mixing:

1. Weigh the water (21.2 g), the aqueous polymer dispersion (43.5 g), and the dispersant (10.9 g) into a cup and stir at 500 rpm.
2. Add polymer powder (23.9 g) into the vortex slowly, steadily increasing stir rate to 1000-1500 rpm.
3. Add 10 drops of thickener (0.1 g) and 1 drop of defoamer (0.01 g) to mixture.
4. Mix for 20 minutes.
5. Add crosslinker (3.3 g) and multi-functional amine (0.1-0.15% of total formulation).
6. Add a further 5-8 drops of thickener (0.05 g) to bring viscosity to 8000 cps, adjust pH to >7 (0.1 g) using aqueous ammonia and recheck after 24 hrs and adjust further if necessary.

### Adhesive Composition IV

### Components:

1. PUD Dispercoll U56 supplied by Covestro (aqueous polymer dispersion); 43.5 g (50% solids, 21.7 g active)
2. Deionized water; 21.2 g
3. Altoma carrier 10628 dispersant supplied by Bolger & O'Hearn (dispersant); 10.9 g (100% active)
4. UNEX 4073RSL powder supplied by Fixatti (polymer powder); 23.9 g (100% active)
5. Altoma clear conc #1953 acrylic emulsion thickener supplied by Bolger & O'Hearn (thickener); 0.1 g
6. FoamBlast 301S supplied by Dystar (defoamer); 0.01 g (1% active)
7. Imprafix 2794 supplied by Covestro (blocked isocyanate); 3.5 g (38% active)
8. Ammonia; 0.1 g (25% aqueous ammonia)

### Method of Mixing:

1. Weigh the water (21.2 g), the aqueous polymer dispersion (43.5 g), and the dispersant (10.9 g) into a cup and stir at 500 rpm.

2. Add polymer powder (23.9 g) into the vortex slowly, steadily increasing stir rate to 1000-1500 rpm.

3. Add 10 drops of thickener (0.1 g) and 1 drop of defoamer (0.01 g) to mixture.

4. Mix for 20 minutes.

5. Add blocked isocyanate (3.5 g).

6. Add a further 5-8 drops of thickener (0.05 g) to bring viscosity to 8000 cps, adjust pH to >7 (0.1 g) using aqueous ammonia and recheck after 24 hrs and adjust further if necessary

### Adhesive Composition V

### Components:

1. NeoRez R9621 supplied by DSM (aqueous polymer dispersion); 20% of total volume
2. NeoRez R600 supplied by DSM (aqueous polymer dispersion); 20% of total volume (33% active)
3. Deionized water; 22.6% of total volume
4. Altoma carrier 10628 dispersant supplied by Bolger & O'Hearn (dispersant); 10.5% total volume (100% active)
5. UNEX 4073RSL powder supplied by Fixatti (polymer powder); 23.1% total volume (100% active)
6. Altoma clear conc #1953 acrylic emulsion thickener supplied by Bolger & O'Hearn (thickener); 0.1% total volume
7. FoamBlast 301S supplied by Dystar (defoamer); 0.1% total volume (1% active)
8. Imprafix 2794 supplied by Covestro (blocked isocyanate); 3.5% total volume (38% active)
9. Ammonia; 0.1% total volume (25% aqueous ammonia)

### Method of Mixing:

1. Weigh the water, the aqueous polymer dispersions, and the dispersant into a cup and stir at 500 rpm.
2. Add polymer powder into the vortex slowly, steadily increasing stir rate to 1000-1500 rpm.
3. Add 10 drops of thickener and 1 drop of defoamer to mixture.
4. Mix for 20 minutes.
5. Add aliphatic blocked isocyanate.
6. Add a further 5-8 drops of thickener to bring viscosity to 8000 cps, adjust pH to >7 using aqueous ammonia and recheck after 24 hrs and adjust further if necessary.

### Adhesive Composition VI Components

1. NeoRez R9621 supplied by DSM (aqueous polymer dispersion); 20% of total volume
2. NeoRez R600 supplied by DSM (aqueous polymer dispersion); 20% of total volume
3. Deionized water; 22.6% of total volume
4. Altoma carrier 10628 dispersant supplied by Bolger & O'Hearn (dispersant); 10.5% total volume (100% active)
5. UNEX 4073RSL powder supplied by Fixatti (polymer powder); 23.1% total volume (100% active)
6. Altoma clear conc #1953 acrylic emulsion thickener supplied by Bolger & O'Hearn (thickener); 0.1% total volume
7. FoamBlast 301S supplied by Dystar (defoamer); 0.1% total volume (1% active)
8. Dispercoll BL XP 2514 by Covestro (crosslinker); 3.5% (40% active in water, 1.3 g active)
9. Ammonia; 0.1% total volume (25% aqueous ammonia)

### Method of Mixing:

1. Weigh the water, the aqueous polymer dispersions, and the dispersant into a cup and stir at 500 rpm.
2. Add polymer powder into the vortex slowly, steadily increasing stir rate to 1000-1500 rpm.
3. Add 10 drops of thickener and 1 drop of defoamer to mixture.
4. Mix for 20 minutes.
5. Add crosslinker.
6. Add a further 5-8 drops of thickener to bring viscosity to 8000 cps, adjust pH to >7 using aqueous ammonia and recheck after 24 hrs and adjust further if necessary.

### Example 2—Testing the Waterproof Seams 105

The water resistance of a waterproof seam may be tested by clamping fabric in a machine and applying 3 psi pressure of water to one side of the fabric for two minutes. The fabric is then examined for any leaks including leaks around the seam and pin-holes in the fabric. An example of a commercially available machine for facilitating the test can be found at testextextile.com/sale/by-category/water-penetration/.

The strength of the adhesive bond forming the waterproof seam is tested using a T-peel test measured using an Instron machine pursuant to ASTM D1876 (ASTM Active Standard ASTM D1876 Developed by Subcommittee: D14.80-Peel Resistance of Adhesives (T-Peel Test)). Typically, three 1-inch samples will be tested and the steady state adhesive strength averaged over the samples is recorded. The peel test is carried out at 12 inch peel/min. The desired bond strength is greater than 3 lbs/inch.

Alternatively, the overlapping seam is tested using an Instron machine for a shear test due to the joint being an overlapping joint. The samples to be tested were 4-inch wide samples and the wider Intron jaws were used. Shear tests are performed pursuant to one or more of ASTM D5868-01 (Active Standard ASTM D5868 Developed by Subcommittee: D14.40-Lap Shear Adhesion for Fiber Reinforced Plastic (FRP) Bonding); ASTM D3163-01 (Active Standard ASTM D3163 Developed by Subcommittee: D14.40-Determining Strength of Adhesively Bonded Rigid Plastic Lap-Shear Joints in Shear by Tension Loading); and/or ASTM D897-08 (Active Standard ASTM D897 Developed by Subcommittee: D14.80-Tensile Properties of Adhesive Bonds).

What is claimed is:

1. A method of manufacturing a waterproof seam comprising:
a. providing a first textile having at least a water penetrable layer and a waterproof layer;
b. providing a second textile having at least a water penetrable layer and a waterproof layer;
c. depositing an adhesive composition onto the water penetrable layer of the first textile;
d. allowing the adhesive composition to completely penetrate through or wet out the water penetrable layer of the first textile;
e. placing the water penetrable layer of the first textile against the waterproof layer of the second textile in an overlapping configuration; and
f. heat sealing the first textile to the second textile, thereby forming an overlapping waterproof seam.

2. The method of claim 1, wherein the adhesive composition comprises an aqueous polymer dispersion, a polymer powder, a dispersing agent, and a thickener.

3. The method of claim 2, wherein the aqueous polymer dispersion is a polyurethane dispersion.

4. The method of claim 2, wherein the adhesive composition further comprises a crosslinker.

5. The method of claim 4, wherein the crosslinker is an isocyanate crosslinker.

6. The method of claim 1, wherein the adhesive composition is deposited in two continuous lines of adhesive composition.

7. The method of claim 6, wherein a distance between the two continuous lines of adhesive composition is about 5 mm.

8. The method of claim 6, wherein the adhesive composition is further deposited as dots dispersed between the two continuous lines of adhesive composition.

9. The method of claim 8, wherein the dots of adhesive composition are about 1 mm to about 1.5 mm in diameter.

10. The method of claim 8, wherein the dots of adhesive composition are spaced about 1 mm to about 1.5 mm apart.

11. The method of claim 1, wherein the waterproof seam has a bond strength of about 3 lbs/inch.

12. The method of claim 1, wherein the waterproof seam has a bond strength of about 8-9 lbs/inch.

13. The method of claim 1, wherein the first textile is heat sealed to the second textile by applying a pressure of 60 psi for a period of 10 to 30 seconds.

14. A waterproof seam joining two textile sections, comprising:
a. a first textile having at least a water penetrable layer and a waterproof layer;
b. a second textile having at least a water penetrable layer and a waterproof layer;
c. an adhesive composition applied to the water penetrable layer of the first textile, wherein the adhesive composition completely penetrated through or wet out the water penetrable layer of the first textile;
d. the water penetrable layer of the first textile positioned against the waterproof layer of the second textile in an overlapping configuration; and
e. an overlapping waterproof seam, formed by a heat seal, coupling the first textile and the second textile via the adhesive composition.

15. The waterproof seam of claim 14, wherein the adhesive composition comprises an aqueous polymer dispersion, a dispersed polymer powder, a dispersing agent, and a thickener.

16. The waterproof seam of claim 15, wherein the aqueous polymer dispersion is a polyurethane dispersion.

17. The waterproof seam of claim 15, wherein the adhesive composition further comprises a crosslinker.

18. The waterproof seam of claim 17, wherein the crosslinker is an isocyanate crosslinker.

19. The waterproof seam of claim 14, wherein the waterproof seam has a bond strength of about 3 lbs/inch.

20. The waterproof seam of claim 14, wherein the waterproof seam has a bond strength of about 8-9 lbs/inch.
